(19) United States
(12) Patent Application Publication
(10) Pub. No.: US 2025/0383035 A1
(43) Pub. Date: Dec. 18, 2025

(54) Antistatic fluid line

(71) Applicant: ContiTech Techno-Chemie GmbH, Karben (DE)

(72) Inventors: Gunther Daniel, Friedberg/Hessen (DE); Dean Christie, Royal Oak, MI (US)

(21) Appl. No.: 19/240,766

(22) Filed: Jun. 17, 2025

Related U.S. Application Data
(60) Provisional application No. 63/660,757, filed on Jun. 17, 2024.

(51) Int. Cl. F16L 11/12

(52) U.S. Cl. CPC F16L 11/12

(57) ABSTRACT

A fluid line assembly includes a fluid line having an electrically non-conductive outer surface, a first end piece coupled to a first end of the fluid line, and a second end piece coupled to a second end of the fluid line. The first end piece is conductive, and an electrical conductor connects the first and second end pieces. The electrical conductor is configured to mitigate the accumulation of static charge along the fluid line assembly.

### BRIEF SUMMARY

The present invention relates to a fluid line assembly comprising a fluid line and two end pieces, each comprising a nipple and optionally a ferrule, wherein the end pieces are made of an electrically conductive material, in particular containing a metal. It is proposed to connect the end pieces to each other by at least one electrical conductor extending along the fluid line.

It is known to use fluid lines such as flexible hoses or rigid pipes to transfer flammable fluids. Such fluid lines have a circular cross-section and usually have an inner layer with an electrically non-conductive inner surface that is in contact with the fluid to be transported. Depending on the area of application of the fluid line, this inner layer can be reinforced from the outside with textile or wire mesh, a wire spiral and other rubber or plastic layers in any combination. Usually, an outermost surface of the fluid line is also electrically non-conductive.

In applications where flammable fluids are present, care must be taken to ensure that there is no accumulation of electrical charge along a section of the fluid line.

A fluid line of the kind mentioned at the outset, in which the risk of electrostatic charging is minimized.

This problem is solved by a fluid line having antistatic features. Further advantages and features can be found in the general description and the embodiment examples.

The fluid line assembly has a fluid line and two end pieces, each of which has a nipple and optionally a ferrule. The fluid line has an innermost surface and an outermost surface that are not electrically conductive, the end pieces being made of an electrically conductive material, in particular containing a metal. The fluid line assembly is characterized by the end pieces being connected to each other by at least one electrical conductor extending along the fluid line to create an electrical connection between the end pieces.

The electrical connection between the end pieces allows a charge exchange to take place, preventing the accumulation of charge in a longitudinal section of the fluid line assembly. The electrical conductor can be, for example, a copper conductor or copper cable. The electrical conductor can be attached to the fluid line from the outside or integrated into it.

In a design of the fluid line assembly according to the invention, the fluid line has an electrically non-conductive outermost layer, which is provided with at least one groove in which the electrical conductor is arranged. Preferably, the electrical conductor is arranged in the groove in such a way that the conductor does not protrude beyond the outermost surface. The at least one groove can run parallel to a longitudinal axis of the fluid line or spiral around the longitudinal axis. Preferably, the at least one groove is made extruded together with the outermost layer.

In a further design of the fluid line assembly, the electrical conductor is a metallic reinforcement member or layer embedded in the fluid line. In this way, there is no need to provide a separate electrical conductor. It is preferable that the reinforcement member in at least one end section of the fluid line is exposed from the outside, i.e. the overlying layer(s) is or are removed, and electrically connected to the corresponding end piece.

It is expressly pointed out that the embodiments of the invention explained above can be combined with the subject-matter of the independent claims, either separately or in any technically sensible combination.

### BRIEF DISCUSSION OF THE SEVERAL VIEWS

Modifications and embodiments of the invention as well as further advantages and details of the invention can be found in the following description and drawing. The schematic figure shows:

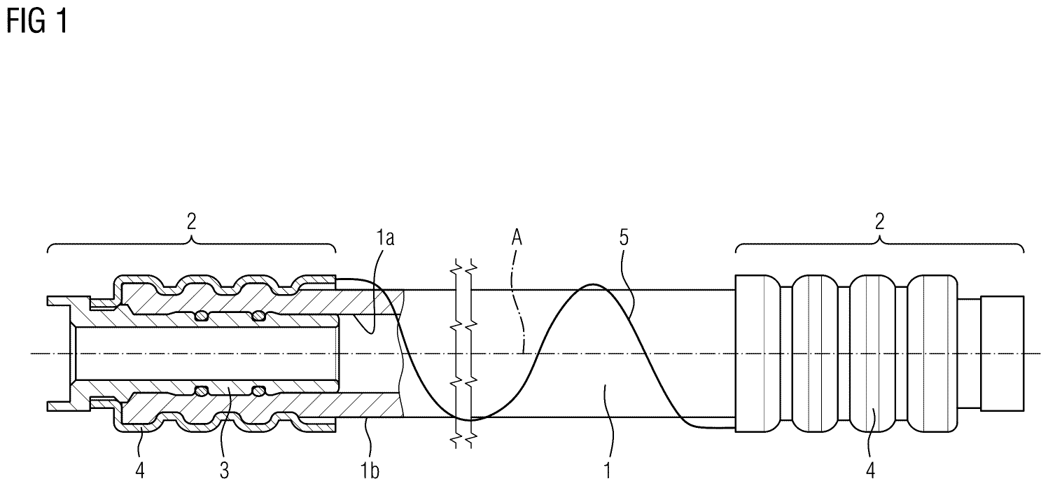

FIG. 1 an embodiment of an invention fluid line assembly in a section view; and

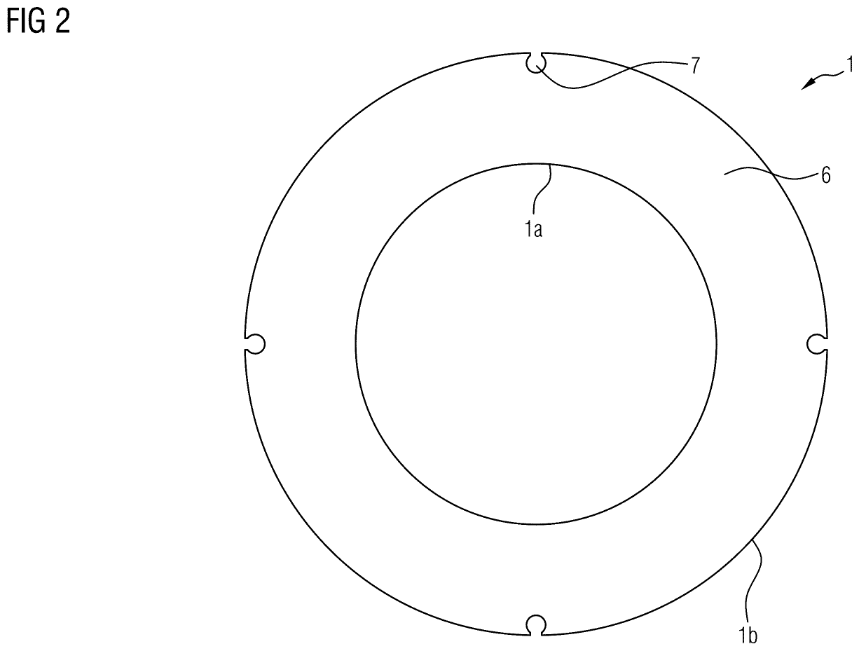

FIG. 2 a fluid line of a further embodiment of an invention fluid line assembly in a cross-sectional view.

Individual technical features of the embodiments described below can also be combined with previously described embodiments as well as the features of the independent claims and any further claims to form subject-matter according to the invention.

### DETAILED DESCRIPTION

FIG. 1 shows an embodiment of a fluid line assembly according to the invention with a fluid line 1 and two end pieces 2, each of which has a nipple 3 and a ferrule 4. The fluid line 1 has an innermost surface 1a and an outermost surface 1b, which are electrically non-conductive. For example, fluid line 1 is a rubber hose or a plastic pipe. The end pieces 2 are made of a conductive material, such as steel or another metal. The end pieces 2 are connected to each other by an electrical conductor 5 extending along the fluid line 1 to create an electrical connection between the end pieces 2, thereby preventing the accumulation of static charge. The electrical conductor 5 extends in a spiral shape around the longitudinal central axis A of the fluid line 1. Several electrical conductors 5 may also be provided.

FIG. 2 shows a fluid line 1 of a further embodiment of a fluid line assembly according to the invention in a cross-sectional view. The fluid line 1 has an electrically non-conductive outermost layer 6, within which several grooves 7 run parallel to the longitudinal central axis A of the fluid line 1. The grooves 7 are used to accommodate electrical conductors 5 in such a way that they do not protrude beyond the outermost surface 1b. In another embodiment, the grooves 7 spiral around the longitudinal central axis A of the fluid line 1.

The fluid line 1 shown in FIG. 2 can be provided with electrical conductors 4 in its grooves 7 and can be used to bridge the end pieces 2 of FIG. 1.

In some aspects, the techniques described herein relate to a fluid line assembly including a fluid line (1) and two end pieces (2), each including a nipple (3) and optionally a ferrule (4), wherein the fluid line (1) has an innermost surface (1a) and an outermost surface (1b) which are electrically non-conductive, wherein the end pieces (2) are made of an electrically conductive material, in particular containing a metal, characterized in that the end pieces (2) are connected to each other by at least one electrical conductor (5) extending along the fluid line (1) to create an electrical connection between the end pieces (2).

In some aspects, the techniques described herein relate to a fluid line assembly, wherein the fluid line (1) has an electrically non-conductive outermost layer (6) which is provided with at least one groove (7) in which the electrical conductor (4) is arranged, in particular wherein the electrical conductor (5) does not protrude beyond the outermost surface (1b).

In some aspects, the techniques described herein relate to a fluid line assembly, wherein the groove (7) is produced extruded together with the outermost layer (6). In some aspects, the techniques described herein relate to a fluid line assembly, wherein the electrical conductor (5) is a metallic reinforcement member embedded in the fluid line (1).

In some aspects, the techniques described herein relate to a fluid line assembly, wherein the reinforcement member is exposed from the outside in at least one end section of the fluid line (1) and electrically conductive connected to the corresponding end piece (2).

In some aspects, the techniques described herein relate to a fluid line assembly including: a fluid line having an outer surface; a first end piece coupled to a first end of the fluid line; a second end piece coupled to a second end of the fluid line; the outer surface is electrically non-conductive; the first end piece is conductive;

and an electrical conductor connecting the first end piece and the second end piece and configured to mitigate accumulation of static charge.

In some aspects, the techniques described herein relate to a fluid line assembly, wherein the outer surface has a groove in which the electrical conductor is arranged.

In some aspects, the techniques described herein relate to a fluid line assembly, wherein the electrical conductor is at or below an outer surface of the fluid line.

In some aspects, the techniques described herein relate to a fluid line assembly, wherein the groove is formed during extrusion of the fluid line.

In some aspects, the techniques described herein relate to a fluid line assembly, wherein a reinforcement member is formed in the fluid line and is exposed from the outside in at least one end section of the fluid line and electrically conductive connected to the corresponding end piece.

In some aspects, the techniques described herein relate to a fluid line assembly, the electrical connector extends is a spiral shape around a longitudinal central axis.

In some aspects, the techniques described herein relate to a fluid line assembly, wherein the electrical connector includes a plurality of electrical conductors.

In some aspects, the techniques described herein relate to a fluid line assembly, wherein the fluid line includes a plurality of grooves for the plurality of electrical conductors.

In some aspects, the techniques described herein relate to a fluid line assembly, the plurality of grooves run parallel to a longitudinal central axis.

In some aspects, the techniques described herein relate to a fluid line assembly including: an end piece having a nipple and a ferrule; a plastic pipe having an end coupled to the end piece; one or more electrical conductors that extend in a spiral shape about a central axis of the plastic pipe and connect to the end; wherein the electrical conductors mitigate accumulation of static charge and are reinforcement members.

In some aspects, the techniques described herein relate to a fluid line assembly, further including a second end piece coupled to a second end of the plastic pipe. In some aspects, the techniques described herein relate to a fluid line assembly, the electrical conductors including steel.

In some aspects, the techniques described herein relate to a fluid line assembly, the electrical conductors formed in a plurality of grooves within the plastic pipe. In some aspects, the techniques described herein relate to a fluid line assembly including: a first end piece having a nipple and a ferrule; a second end piece having a nipple and a ferrule; a rubber hose coupled to the first end piece and the second end piece; one or more electrical conductors that extend in a spiral shape about a central axis 14, the electrical conductors including steel.

In some aspects, the techniques described herein relate to a fluid line assembly, the electrical conductors embedded in the rubber hose.

In some aspects, the techniques described herein relate to a fluid line assembly, the rubber hose having a non-conductive outermost layer having a plurality of grooves for the plurality of electrical conductors.

In some aspects, the techniques described herein relate to a fluid line assembly, the rubber hose further including a non-conductive innermost layer.

In some aspects, the techniques described herein relate to a fluid line assembly, wherein electrical connectors are connected to the first end pie by removal of an overlying layer of the rubber hose.

In addition, it should be noted that “comprising” does not exclude other elements or steps, and “a” or “one” does not exclude a multitude.

The scope of protection of the present invention is given by the patent claims and is not limited by the features explained in the description or shown to the figures.

1. A fluid line assembly comprising:
a fluid line having an outer surface;
a first end piece coupled to a first end of the fluid line;
a second end piece coupled to a second end of the fluid line;
the outer surface is electrically non-conductive;
the first end piece is conductive; and
an electrical conductor connecting the first end piece and the second end piece and configured to mitigate accumulation of static charge.

2. The fluid line assembly of claim 1, wherein the outer surface has a groove in which the electrical conductor is arranged.

3. The fluid line assembly of claim 2, wherein the electrical conductor is at or below an outer surface of the fluid line.

4. The fluid line assembly of claim 3, wherein the groove is formed during extrusion of the fluid line.

5. The fluid line assembly of claim 4, wherein a reinforcement member is formed in the fluid line and is exposed from the outside in at least one end section of the fluid line and electrically conductive connected to the corresponding end piece.

6. The fluid line assembly of claim 1, the electrical connector extends is a spiral shape around a longitudinal central axis.

7. The fluid line assembly of claim 1, wherein the electrical connector comprises a plurality of electrical conductors.

8. The fluid line assembly of claim 7, wherein the fluid line comprises a plurality of grooves for the plurality of electrical conductors.

9. The fluid line assembly of claim 8, the plurality of grooves run parallel to a longitudinal central axis.

10. A fluid line assembly comprising:
an end piece having a nipple and a ferrule;
a plastic pipe having an end coupled to the end piece;
one or more electrical conductors that extend in a spiral shape about a central axis of the plastic pipe and connect to the end;
wherein the electrical conductors mitigate accumulation of static charge and are reinforcement members.

11. The fluid line assembly of claim 10, further comprising a second end piece coupled to a second end of the plastic pipe.

12. The fluid line assembly of claim 11, the electrical conductors comprising steel.

13. The fluid line assembly of claim 12, the electrical conductors formed in a plurality of grooves within the plastic pipe.

14. A fluid line assembly comprising:
a first end piece having a nipple and a ferrule;
a second end piece having a nipple and a ferrule;
a rubber hose coupled to the first end piece and the second end piece;
one or more electrical conductors that extend in a spiral shape about a central axis of the plastic pipe and connect to the first end and the second end; and
wherein the electrical conductors mitigate accumulation of static charge and are reinforcement members.

15. The fluid line assembly of claim 14, the electrical conductors comprising steel.

16. The fluid line assembly of claim 15, the electrical conductors embedded in the rubber hose.

17. The fluid line assembly of claim 16, the rubber hose having a non-conductive outermost layer having a plurality of grooves for the plurality of electrical conductors.

18. The fluid line assembly of claim 17, the rubber hose further comprising a non-conductive innermost layer.

19. The fluid line assembly of claim 14, wherein electrical connectors are connected to the first end pie by removal of an overlying layer of the rubber hose.
